(19) United States
(12) Patent Application Publication
(10) Pub. No.: US 2026/0268147 A1
(43) Pub. Date: Sep. 10, 2026

(54) RETROACTIVE PREDICTION FRAMEWORK FOR SEQUENTIAL MESSAGE FILTERING AND RESOURCE OPTIMIZATION

(71) Applicant: Optum Services (Ireland) Limited, Dublin (IE)

(72) Inventors: Kevin LARKIN, Kildare (IE); Richard MCALEAVEY, Balscadden (IE); Amit Kumar UPADHYAY, Dublin (IE); Julie A ROMANENGHI, Waterford (IE)

(21) Appl. No.: 18/637,533

(22) Filed: Apr. 17, 2024

(51) Int. Cl. G06N 3/084

(52) U.S. Cl. CPC G06N 3/084

(57) ABSTRACT

Various embodiments of the present disclosure provide retroactive prediction frameworks for sequentially filtering messages to optimize network efficiency and processing resource utilization in a complex prediction domain. The techniques may leverage a pre-filtering rule set to identify a set of candidate data objects from an object data store. The set of candidate data objects may be augmented with a plurality of composite recovery scores generated by a machine learning prioritization model and then filtered and ranked to create a prioritized ranking data structure. The prioritized ranking data structure may be leveraged to selectively provide verification requests to a remote verification platform.

### BACKGROUND

Various embodiments of the present disclosure address technical challenges related to processing resource optimization in a complex prediction domain, such as investigative technologies that leverage predictions to optimize resource utilization across large datasets. Traditionally, predictive techniques leveraged by investigative technologies are more aligned to a prospective identification of objects of interest to prevent the occurrence of a target event. An example in the healthcare space may include a coordination of benefits (COB) investigation process that attempts to predict and avoid an overpayment of a medical claim before the payment is made. Due to their prospective nature, these techniques have limited access to predictive features for training predictive models, which negatively impacts the performance of prospective predictive models. Other techniques include data mining-based investigations that evaluate and detect a target event after the occurrence of the target event. Such techniques require an evaluation of large datasets and, due to processing and timing constraints, are unable to be retroactively applied to prevent or address a detected target event. As an example, using the healthcare analogy above, a data mining approach to a COB process may detect that an overpayment is made, but the detection may not occur until after a claim is closed and remedial measures are no longer available.

Various embodiments of the present disclosure make important contributions to traditional communication techniques by addressing these technical challenges, among others.

### BRIEF SUMMARY

Various embodiments of the present disclosure address the above-described technical challenges by providing a retroactive prediction framework for filtering messages and optimizing processing resources across a large dataset to both optimize resource allocation and reduce timing delays between the occurrence and detection of a target event. To do so, a retroactive prediction framework may employ a plurality of sequential filtering and prediction models that sequentially filter, and rank data objects based on a predictive outcome for the data object. For instance, a pre-filtering rule set may be applied to an object data store to extract a set of candidate data objects for the prediction framework. Once extracted, the set of candidate data object may be augmented with composite recovery scores and other predictive insights using a sequence of machine learning models. Using these insights, the set of candidate data objects may be further filtered and ranked to generate a prioritized ranking data structure that may be leveraged to selectively verify a target event and initiate a predictive action to address the target event. By doing so, the techniques of the present disclosure may filter, and rank data objects based on their predictive likelihood of a positive return. This, in turn, allows for the allocation of processing resources in a manner that optimizes a return on the processing resources. Moreover, by reducing and directing the allocation of processing resources, the techniques of the present disclosure decrease the time, cost, and number of data objects for evaluation, which allows for the near real time application of data mining approaches to retroactively address a target event within an applicable time period.

In some embodiments, a computer-implemented method comprises identifying, by one or more processors and using a pre-filtering rule set, a set of candidate data objects from an object data store; generating, by one or more processors using a machine learning prioritization model, a plurality of composite recovery scores for the set of candidate data objects; generating, by the one or more processors, a prioritized ranking data structure for the set of candidate data objects based on the plurality of composite recovery scores; providing, by the one or more processors and to a remote verification platform, a verification request for a selected data object of the set of candidate data objects based on the prioritized ranking data structure; and responsive to a verification response from the remote verification platform, initiating, by the one or more processors, a prediction-based action for the selected data object.

In some embodiments, a computing system comprises memory and one or more processors communicatively coupled to the memory, the one or more processors are configured to identify, using a pre-filtering rule set, a set of candidate data objects from an object data store; generate, using a machine learning prioritization model, a plurality of composite recovery scores for the set of candidate data objects; generate a prioritized ranking data structure for the set of candidate data objects based on the plurality of composite recovery scores; provide, to a remote verification platform, a verification request for a selected data object of the set of candidate data objects based on the prioritized ranking data structure; and responsive to a verification response from the remote verification platform, initiating a prediction-based action for the selected data object.

In some embodiments, one or more non-transitory computer-readable storage media includes instructions that, when executed by one or more processors, cause the one or more processors to identify, using a pre-filtering rule set, a set of candidate data objects from an object data store; generate, using a machine learning prioritization model, a plurality of composite recovery scores for the set of candidate data objects; generate a prioritized ranking data structure for the set of candidate data objects based on the plurality of composite recovery scores; provide, to a remote verification platform, a verification request for a selected data object of the set of candidate data objects based on the prioritized ranking data structure; and responsive to a verification response from the remote verification platform, initiating a prediction-based action for the selected data object.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a dataflow diagram showing example data structures and modules for implementing a retrospective prediction framework in accordance with some embodiments discussed herein.

FIG. 5 is a flowchart diagram of an example retroactive prediction process in accordance with some embodiments discussed herein.

FIG. 6 is a flowchart diagram of an example machine learning training process in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

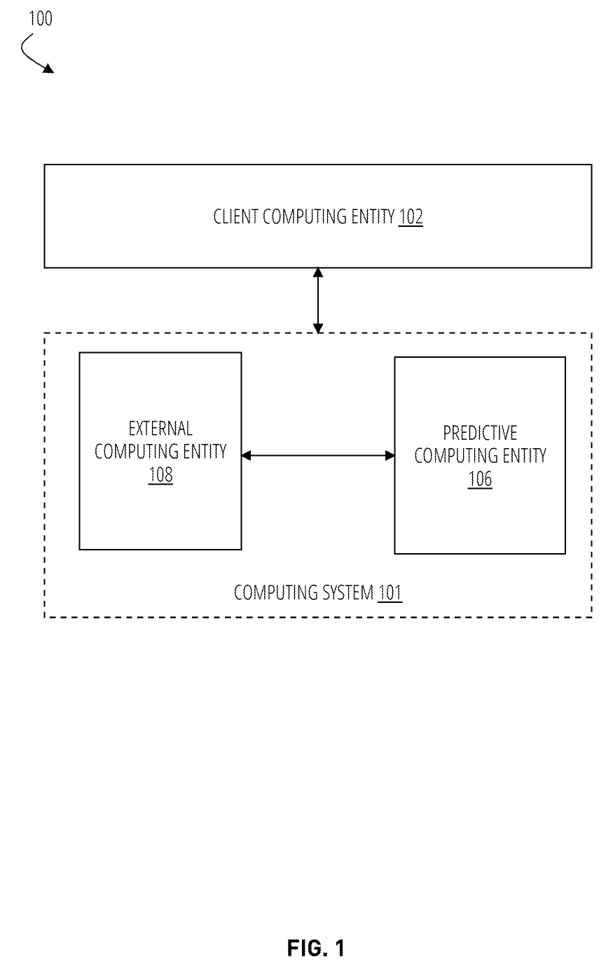

FIG. 1 provides an example overview of an architecture 100 in accordance with some embodiments of the present disclosure. The architecture 100 includes a computing system 101 configured to receive request, such as generative text requests, from client computing entities 102, process the requests to generate generative text outputs, and provide the generated text outputs to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more machine learning models may be trained to generate predictive insights, such as composite recovery scores, and/or the like, generative text in various forms, such as recovery notifications, and/or the like. The models may form at least a portion of a prediction framework that may be configured to automatically filter, rank, and modify one or more data object for a prediction process and then leverage the filtered, ranked, and modified data objects to perform a prediction-based action. This technique will improve processing resource allocation, reduce proceeding time constraints, and enable the application of traditionally isolated data mining techniques in a near real time, retroactive prediction pipeline.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive data objects from client computing entities 102, process the data objects to generate outputs, such as composite recovery scores, recovery notifications, and/or the like, and provide the generated outputs to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., prediction techniques, processing resource allocation techniques, data filtering techniques, generative text techniques, and/or the like) described herein. The external computing entities 108, for example, may include and/or be associated with one or more entities that may be configured to receive, transmit, store, manage, and/or facilitate datasets, such as the object data stores, recovery training stores and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

### A. Example Predictive Computing Entity

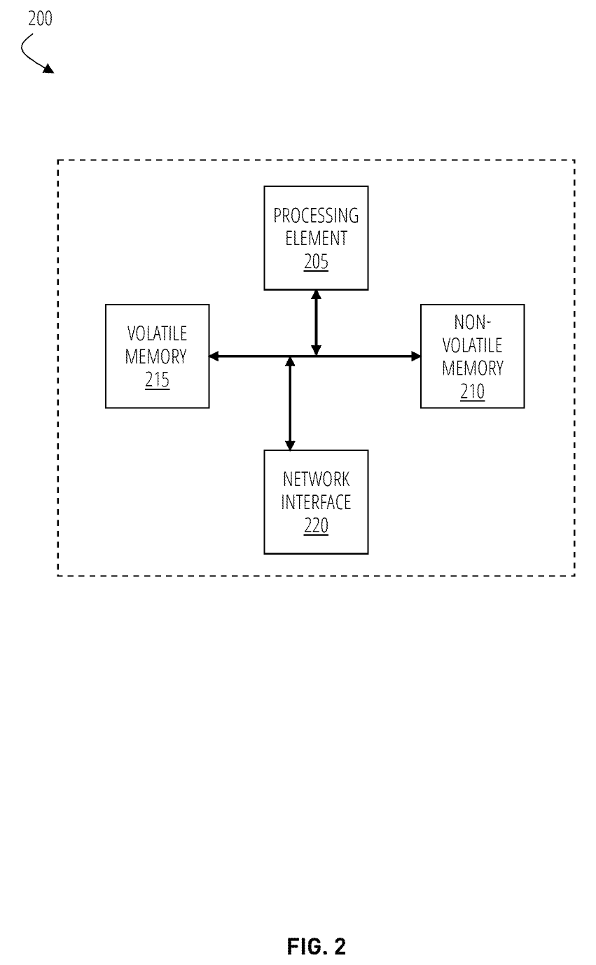

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

### B. Example Client Computing Entity

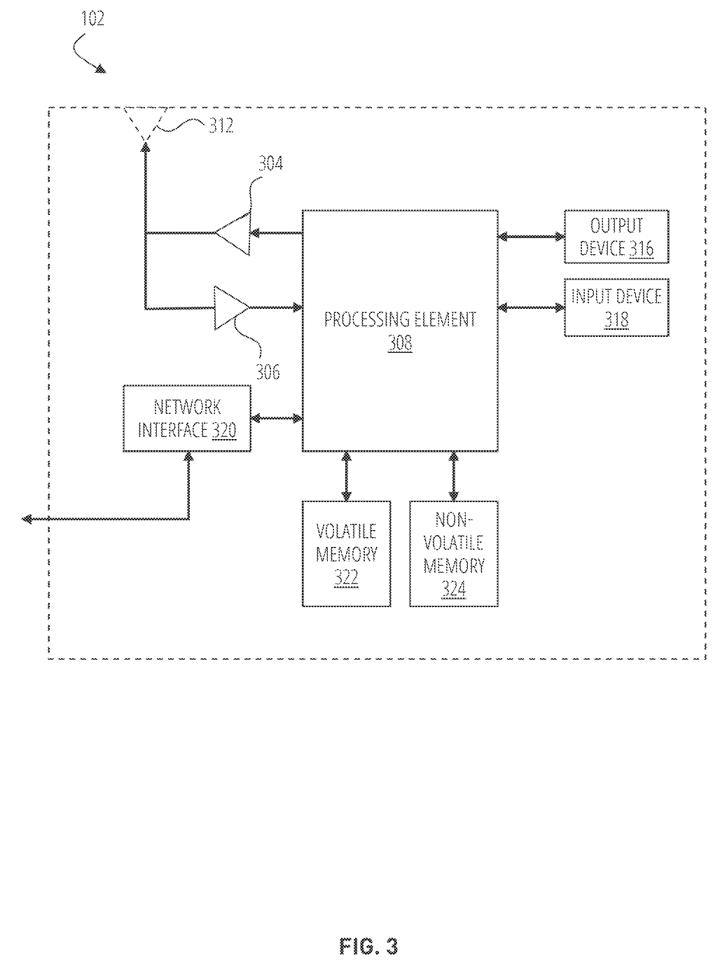

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Examples of Certain Terms

In some embodiments, the term “object data store” refers to a data structure that describes a plurality of data objects for a prediction domain. An example object data store may include any type (and any number) of data storage structures including, as examples, one or more linked lists, databases (e.g., relational databases, graph database, etc.), and/or the like. In some embodiments, an object data store may include a plurality of data objects, each reflective of an interaction between two entities within the prediction domain. In some examples, an object data store may correspond to a particular platform. For instance, the object data store may include a plurality of data objects that are reflective of interactions between entities associated with a particular platform within the prediction domain.

In some embodiments, the term “data object” refers to a data entity that describes a component (e.g., data record, node, etc.) of an object data store. A data object, for example, may include a historical record that records one or more attributes of a historical interaction within a prediction domain. In some examples, a data object may include one or more object attributes, predictive features, and/or the like, that may be leveraged by one or more techniques of the present disclosure to generate predictive insights for a prediction domain.

The information recorded by a data object may depend on the prediction domain. As an example, a data object may correspond to a medical claim in a clinical prediction domain. For example, a data object may include a medical record that describes one or more characteristics of a clinical interaction. In some examples, each data object may include a value transfer (e.g., a claim reimbursement, etc.) from a particular platform (e.g., an insurance platform) to a provider (e.g., a healthcare provider, etc.) associated with a medical claim. In this respect, the one or more attributes of the data object may be assessed to predict a likelihood of recovery for at least a portion of the value transfer by coordinating the value transfer across multiple platforms co-affiliated with a data object.

In some embodiments, the term “object attribute” refers to a data entity that describes a characteristic of a data object. An object attribute, for example, may include a parameter, feature, and/or the like that describes a recorded aspect of a historical record. An object attribute may include a predictive feature, an object status, a value parameter, a predicted recovery parameter, a prediction entity identifier, a primary platform identifier, a secondary platform identifier, and/or any other type of characteristic for a data object.

In some embodiments, the term “predictive feature” refers to an object attribute that is predictive of an outcome for a prediction domain. For example, a predictive feature may include an engineered and/or extracted object attribute that is weighted as relevant to an outcome. A predictive feature, for example, may include an input to a machine learning model, such as the one or more models of the present disclosure, which is at least partially determinative of an output by the model. A predictive feature may depend on a prediction domain. As one example, in a clinical prediction domain for predicting a likelihood of recovery for a medical claim, a predictive feature may include a provider identifier (e.g., identifying a healthcare provided issuing a medical claim), a location identifier (e.g., a jurisdiction, district, state, relative location to a designated location, etc.), a timing identifier (e.g., a time of service, etc.), and/or one or more other claim attributes that may have an observed impact on a recovery outcome for a medical claim.

In some embodiments, the term “prediction entity” refers to an object attribute that describes an entity associated with a data object. By way of example, a prediction entity may identify a member of a particular platform that is associated with the data object. As an example, in a clinical domain, the prediction entity may identify a patient that receives healthcare services during a clinical interaction recorded by a data object.

In some embodiments, the term “object status” refers to an object attribute that a state of the data object within a prediction domain. For example, an object status may be one of a plurality of predefined object states that respectively describe a condition of a data object with respect to the prediction domain. The predefined object states, for example, may reflect a status of data object with respect to a value sharing process. By way of example, an object status may include a pending status (e.g., indicating that a value transfer has not yet been performed, etc.), a completed status (e.g., indicating that a value transfer has been performed, etc.), a closed status (e.g., indicating that a recovery time period has elapsed, etc.), an appealed status (e.g., indicating that an appeal process has been initiated, etc.), and/or the like. In some examples, an object status for a data object may be modified over time to track the condition of the data object as it progresses through a value sharing process.

In some embodiments, the term “predicted recovery parameter” refers to an object attribute that describes a predicted recovery value for a data object. For example, a predicted recovery parameter may include a predicted value that is derived from a value parameter of a data object. By way of example, a value parameter may describe a requested value transfer, such as a claimed amount for a clinical procedure, etc., for the data object and the predicted recovery parameter may be a proportion of the requested value transfer.

In some embodiments, the term “pre-filtering rule set” refers to a data entity that describes criteria for filtering data objects from an object data store. A pre-filtering rule set may be configured to identify data objects that may be retroactively processed, via a prediction framework, to generate one or more retroactive insights. In some examples, the pre-filtering rule set may define criteria to filter out scenarios where the prediction framework should not be applied in order to optimize computing resources. For example, the criteria may filter out data objects that (i) are subject to one or more other, superseding predictive processes and/or (ii) fail to satisfy one or more preliminary requirements of the prediction framework to generate a set of candidate data objects. In this way, a robust dataset may be filtered to create a set of data objects that is small enough for the application of real-time, complex, prediction frameworks, such as the prediction framework of the present disclosure that leverages a machine learning prioritization model in combination with a sequence of pre- and post-processing techniques to generate individualized insights for a data object.

In some examples, the pre-filtering rule set may be tailored to a particular process, such as a COB investigation process, and may be dynamically updated based on one or more insights of the particular process. In some examples, the pre-filtering rule set may define one or more exclusionary statuses for a particular process. The exclusionary statuses may correspond to a prediction entity of a data object. In this manner, a plurality of data objects may be filtered based the characteristics of a plurality of prediction entities respectively corresponding to the data objects. In addition, or alternatively, a pre-filtering rule set may define a target attribute for a data object. By way of example, a pre-filtering rule set may define (i) one or more exclusionary entity statuses for identifying one or more target prediction entities that are respectively associated with one or more data objects and (ii) an eligibility status for identifying a set of candidate data objects from the one or more data objects.

In some embodiments, the term “exclusionary entity status” refers to a configurable data parameter that describes an entity status of a target prediction entity for a retroactive prediction framework. An exclusionary entity status, for example, may include one or more predefined entity states that respectively describe a candidate condition of a prediction entity. The predefined object states, for example, may reflect a status of prediction entity with respect to a value sharing process (e.g., a COB process, etc.).

In some examples, a first exclusionary entity status may include a pending investigation status indicating that a prediction entity has not been investigated for the value sharing process. A second exclusionary entity status may include a priority pending investigation state indicating that a prediction entity has been identified for investigation but has not been investigated for the value sharing process. A third exclusionary entity status may include a failed investigated state indicating that the prediction entity has been investigated and does not comply with a value sharing process. A fourth exclusionary entity status may include a probable pending investigation state indicating that a prediction entity has a probability for complying with a value sharing process but has not been investigated for the value sharing process.

In some examples, the exclusionary entity statuses may be applied to a plurality of prediction entities to identify one or more target prediction entities that do comply with the exclusionary entity statuses. The target prediction entities, for example, may include an accepted value sharing status indicating that the prediction entities have been investigated and do comply with a value sharing process.

In some embodiments, the term “eligibility status” refers to a configurable data parameter that describes an object status of a data object for a retroactive prediction framework. In some examples, an eligibility status may include a completed status indicating that a value transfer has been performed and that the data object is not closed or appealed.

In some embodiments, the term “set of candidate data objects” refers to one or more data objects from an object data store that are candidates for a retroactive prediction framework. A set of candidate data objects may include any number of candidate objects, from the object data store, which comply with a pre-filtering rule set. For example, each of the candidate data objects of a set of candidate data objects may be filtered from the object data store based on one or more exclusionary statuses and an eligibility status associated with the candidate data objects (and/or a prediction entity associated therewith).

The set of candidate data objects may include one or more different data types based on the prediction domain. In one example, for a clinical COB domain, the set of candidate data objects may include one or more paid medical claims for members that are flagged for potentially having coverage with a second insurance provider. In this way, a set of paid claims may be injected as an initial input to a retroactive prediction framework to retroactively recover a value transfer based on a value sharing process. In some examples, the secondary platform may be predicted for each of the candidate data objects based on one or more object attributes (e.g., one or more demographic attributes, claim attributes, etc.) and stored as an additional attribute with the data object.

As described herein, each candidate data object of the set of candidate data objects may be processed in accordance with a retroactive prediction framework to generate one or more recovery insights for prioritizing the candidate data object with respect to other candidate data objects. The retroactive prediction framework, for example, may include a machine learning prioritization model that continuously trained to generate composite recovery scores for candidate data objects.

In some embodiments, the term “machine learning prioritization model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning prioritization model may include any type of model configured, trained, and/or the like to generate a composite recovery score, as described herein. A machine learning prioritization model may include one or more of any type of machine learning model including one or more supervised, unsupervised, semi-supervised, and/or reinforcement learning models. In some embodiments, the machine learning prioritization model may include multiple models configured to perform one or more different stages of a prioritization process.

In some embodiments, the machine learning prioritization model includes a decision tree architecture, such as a classification decision tree, a regression decision tree, and/or the like. By utilizing a decision tree architecture, the machine learning prioritization model may improve explainability with respect to a prioritization process. In some examples, the decision tree architecture may be trained, using one or more supervisory training techniques, such as back-propagation of errors, to optimize a recovery loss function. The recovery loss function, for example, may include a Gini impurity index, mean square error, Chi square measure, and/or the like. In some examples, the recovery loss function may be applied to a plurality of training outputs generated using a recovery training store. As described herein, a recovery training store may include a plurality of historical data object pairs with a plurality of recovery labels. The machine learning prioritization model may be trained to generate composite recovery predictions based on a correspondence between the plurality of training outputs and the plurality of recovery labels of the plurality of historical data object pairs.

In some embodiments, the term “recovery training store” refers to a data structure that describes a plurality of training data objects for a prediction domain. An example recovery training store may include any type (and any number) of data storage structures including, as examples, one or more linked lists, databases (e.g., relational databases, graph database, etc.), and/or the like. In some embodiments, a recovery training store may include a plurality of historical data object pairs. The plurality of historical data object pairs may include one or more historical, synthetic, and/or simulated data objects that are stored, generated, and/or simulated for training a machine learning model, providing compliance records for recovery decisions, and/or the like.

In some embodiments, a recovery training store includes one or more predictive features for each of a plurality of historical data object pairs. The predictive features, for example, may include one or more entity attributes (e.g., prediction entity attributes, etc.) associated with an entity corresponding to a historical data object. In some examples, the predictive features may be domain specific. For instance, in a clinical domain, the recovery training store may include a plurality of historical medical claims labeled with one or more claim recovery outcomes. In such a case, additional predictive features may include patient profiles, provider profiles, and/or the like of one or more members and/or providers associated with each medical claim.

In some embodiments, the term “historical data object pair” refers to a component of a recovery training store that describes a training entry for a machine learning model. A historical data object pair, for example, may include a historical, synthetic, and/or simulated data object and a recovery label corresponding to the data object. A historical data object pair may be domain specific. For example, in a clinical domain, a historical data object pair may include a medical claim with a recovery label identifying a recovery outcome for the medical claim.

In some embodiments, the term “recovery label” refers to a data entity that describes a training label for a training data object. A recovery label may describe a historical, synthetic, and/or simulated outcome for a corresponding data object. A recovery label, for example, may include a positive label category and/or a negative label category that respectively describe one or more categories of outcomes for a data object. The positive and negative label categories may define a binary classification label by breaking a complex set of outcomes into a positive and negative classification. For instance, a positive label category may include a plurality of different positive outcomes that are each reflective of a positive overall effect (e.g., conversion of processing resources to value gain, etc.) of applying a prediction framework to a data object. A negative label category may include a plurality of different negative outcomes that are each reflective of a negative overall effect (e.g., waste of processing resources, etc.) of applying a prediction framework to a data object.

A recovery label may be domain specific. As an example, in a clinical domain, a positive label category may include a claim recovery for a medical claim, whereas a negative label category may include a claim closure before a claim recovery and/or an appeal after a claim recovery for a medical claim.

In some embodiments, the term “composite recovery score” refers to an output of a machine learning prioritization model. A composite recovery score may include a value that is reflective of a likelihood of a positive label category for a data object. In some examples, a composite recovery score may include a number between 0 and 1. In addition, or alternatively, a composite recovery score may include a ratio, percentage, and/or a binary and/or real number output reflective of a predicted recovery outcome for an input data object. In some examples, a composite recovery score represents a likelihood that an input data object (e.g., a medical claim in a clinical domain) may be recovered in response to the application of a prediction framework. A composite recovery score, for example, may be an inverse of a combined probability that a data object (e.g., medical claim) is closed and/or appealed before and/or after recovery.

In some embodiments, the term “prioritized ranking data structure” refers to a data structure that describes a prioritized set of candidate data objects for a resource intensive recovery process. A prioritized ranking data structure includes one or more data objects from a set of candidate data objects that are filtered and ranked based on their composite recovery scores. For example, a prioritized ranking data structure may be generated by comparing the composite recovery scores to a tiered recovery score threshold. A prioritized ranking data structure may include each of the data objects that satisfy the tiered recovery score threshold. In some examples, the data objects of the prioritized ranking data structure may be ranked based on their composite recovery scores to efficiently assign limited computing resources to data objects with the highest relative likelihoods of a positive outcome. In some examples, a relative likelihood may include a composite recovery score that is weighted by a predicted recovery parameter for the data object.

In some embodiments, the term “tiered recovery score threshold” refers to a configurable tiered threshold parameter that describes criteria for a resource intensive recovery process. A tiered recovery score threshold may define a plurality of composite recovery score thresholds for a recovery process. Each of the plurality of composite recovery score thresholds may correspond to a predicted recovery parameter range. In some examples, the composite recovery score thresholds may include escalating thresholds relative to decreasing predicted recovery parameter ranges. In this manner, the tiered recovery score threshold may enforce a higher composite recovery score the lower the predicted recovery parameter is. By way of example, the tiered recovery score threshold may include first threshold for a first recovery parameter range and a higher, second threshold for a second recovery parameter range that is lower than the first recovery parameter range.

In some embodiments, the term “remote verification platform” refers to a computing system associated with a verification platform. A remote verification platform, for example, may include an example computing entity, including one or more processors and/or memory storing instructions that, when executed by the one or more processors, cause the computing entity to perform one or more operations described herein. In some examples, a remote verification platform may include at least a portion of a cloud server that is accessible to another computing entity. By way of example, in a clinical network domain, a remote verification platform may include a computing entity that is accessible by an insurance platform for verifying information for a medical claim at a cost to the insurance platform. By way of example, a remote verification platform may include a clearinghouse 270/271 that may be paid to identify coverage details for a patient, a healthcare provider, and/or for a specific medical claim.

In some embodiments, the term “verification request” refers to a data entity that describes a communication to a remote verification platform. A verification request may include one or more API based messages that may be provided to the remote verification platform through a platform-platform interface. In some examples, a verification request may include a request to confirm one or more object attributes for a data object. The object attributes may depend on a prediction domain. In a clinical prediction domain, the verification request may include a request to confirm (1) an identify of a secondary platform for a data object, (2) the time range of overlapping coverages between a primary and secondary platform, and/or (3) a coverage type of the secondary platform.

In some embodiments, the term “verification response” refers to a data entity that describes a communication from a remote verification platform. A verification response may include one or more API based messages that may be received from the remote verification platform through a platform-platform interface. In some examples, a verification response may include a response to a verification request. For example, the verification response may confirm one or more object attributes for a data object. The object attributes may depend on a prediction domain. In a clinical prediction domain, the verification response may include a response to confirm (1) the identify of a secondary platform for a data object, (2) the time range of overlapping coverages between a primary and secondary platform, and/or (3) the coverage type of the secondary platform.

In some embodiments, the term “prediction-based action” refers to a recovery action responsive to a detection of a predicted recovery outcome. A prediction-based action may include any of a plurality of different computing tasks and/or actions to initiate a recovery outcome. In some examples, a prediction-based action may be performed in response to a verification response verifying that a data object is associated with an overlapping range of coverage between a primary and secondary platform. In such a case, a prediction-based action may include an automated recovery notification process in which a recovery notification is generated and provided to a secondary platform. In addition, or alternatively, a prediction-based action may include a providing one or more computing instructions to a client device (e.g., a provider client device, user client device, etc.) to initiate a notification, via a display, one or more vibration actuators, and/or the like, for a user. In this manner, a physical action may be performed to initiate a recovery outcome for a data object. In some embodiments, a prediction-based action may be initiated by a recovery model.

In some embodiments, the term “recovery model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A recovery model may include any type of model configured, trained, and/or the like to initiate a prediction-based action in response to a detection of a predicted recovery outcome. For example, a recovery model may include a data mining model configured to automatically generate a recovery notification and provide the recovery notification to a provider associated with a data object.

In some examples, a recovery model may include a generative model configured to generate natural language text from a data object. For example, the generative model may include a large language model (LLM), such as a generative pre-trained transformer (GPT) model. In some examples, the generative model may include a GPT-4 model and/or any other machine learning model with generative capabilities. The generative model may be configured to automatically generate the recovery notification based on a generative prompt (e.g., a few shot prompt with one or more notification examples, etc.) identifying the data object and/or one or more object attributes thereof.

In some examples, a recovery model may include a model-provider interface for facilitating communication between the recovery model and one or more provider systems. In some examples, the model-provider interface may include an API that defines communications between the recovery model and the one or more provider systems. In some examples, a recovery notification may be provided to a provider via the model-provider interface.

In some examples, a recovery model may monitor a recovery operation for a data object to identify a recovery outcome. In response to a recovery outcome, the recovery outcome may store the recovery outcome in the recovery training store. In this manner, the recovery outcome may be leveraged to generate a historical data object pair to continuously retrain a machine learning model, such as the machine learning prioritization model. In some examples, in response to a negative recovery outcome, a prediction entity may be monitored to identify one or more information changes in the data object profile. In response to a detected change, the data object may be reanalyzed using the prediction framework of the present disclosure.

In some embodiments, the term “recovery notification” refers to a data entity that describes generative text that is output by a recovery model responsive to a potential positive recovery outcome. A recovery notification may depend on a prediction domain. By way of example, in a clinical domain, a recovery notification may include an overpayment letter that may request a recovery operation by a provider associated with a medical claim.

### IV. Overview

Various embodiments of the present disclosure provide message filtering, computing resource optimization, and machine learning training techniques that improve upon traditional large data processing technologies. To do so, embodiments of the present disclosure provide a retroactive prediction framework that sequentially filters data objects based on predictive insights generated across a multi-stage prediction pipeline. Traditional data processing techniques are limited by available processing resources, the complexities of a prediction process, and requirements for access to remote resources. These limitations reduce the throughput, increase the latency, and restrict the scope of coverage provided by such processing techniques and, in some cases, may result in an inability to react to predictive insights within time constraints necessary to alleviate problems identified using the processing techniques. As described above, this causes complex data mining processes to be reduced to post-action data analysis for evaluating data trends as opposed to pre-action data analysis that may inform prediction-based actions. To alleviate these technical challenges, the retroactive prediction framework optimizes computing resources by performing sequential predictions to filter data objects between each stage of the multi-stage prediction pipeline. The sequential predictions are then leveraged to selectively perform network communications based on a predicted outcome of the communication. By doing so, some of the techniques of the present disclosure optimize resource allocation across a prediction pipeline, which, in turn, enables near real time data processing techniques for initiating retroactive prediction-based actions regardless of time constraints that have traditionally prevented such actions. In this manner, large datasets may be selectively processed to initiate prediction-based actions that are uncaptured by traditional data processing techniques.

In some embodiments, some of the techniques of the present disclosure provide machine learning training techniques for performing one or more stages of a retroactive prediction framework. For example, the retroactive prediction framework may leverage a machine learning prioritization model that is configured and continuously trained to prioritize data objects for an allocation of computing resources. The machine learning prioritization model, for example, may be trained using historical data reflective of a return on the allocation of processing resources for a historical data object. Once trained, the machine learning prioritization model may be leveraged to rank and filter data objects at one or more stages of the retroactive prediction framework. To address model drift challenges specific to machine learning models, the results of prediction-based actions initiated using the retroactive prediction framework may be recorded and continuously added to an adaptive training data store, which may be used to continuously retrain the machine learning prioritization model based on real world outcomes. By doing so, the retroactive prediction framework may leverage improved machine learning training techniques to adaptively allocate processing resources based on changes within a prediction domain.

Examples of technologically advantageous embodiments of the present disclosure include: (i) a retroactive prediction framework for sequentially filtering data objects, (ii) machine learning training techniques for addresses model drift-based performance degradations, (iii) near real time prediction-based actions for acting on data mining insights within traditionally prohibitive time constraints, among other aspects of the present disclosure. Other technical improvements and advantages may be realized by one of ordinary skill in the art.

### V. Example System Operations

As indicated, various embodiments of the present disclosure make important technical contributions to message filtering, processing resource optimization, and machine learning that are practically applied to enable retroactive prediction-based actions in a complex prediction domain. In particular, systems and methods are disclosed herein that implement a retroactive prediction framework to selectively extract, augment, filter, and then rank a plurality of data objects from an object data store. By doing so, data objects may be selectively verified using limited network messages to remote platforms and, if verified, may be handled in near real time by initiating prediction-based actions tailored to the data object. This, in turn, enables retroactive prediction-based actions that achieve time constraints traditionally prohibitive to state-of-the-art investigative processes.

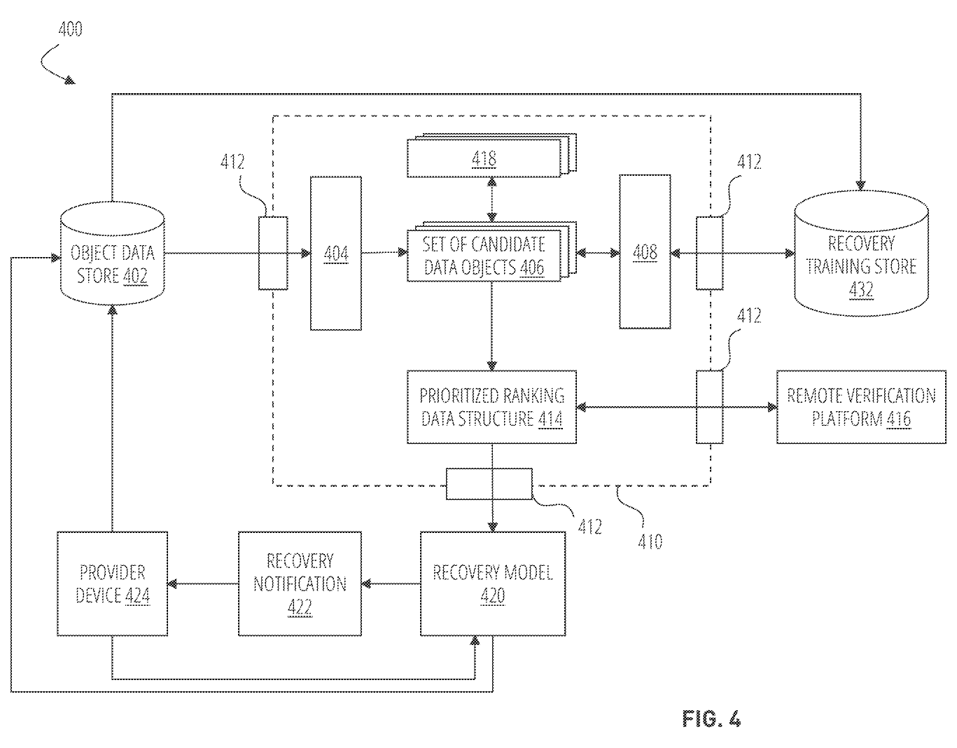

FIG. 4 is a dataflow diagram 400 showing example data structures and modules for implementing a retrospective prediction framework in accordance with some embodiments discussed herein. The dataflow diagram 400 includes a plurality of computing entities that collectively operate to through a prediction framework 410. The prediction framework 410 sequentially filters data objects from an object data store 402 to optimize the allocation of processing resources across a large dataset. As depicted, the prediction framework 410 may leverage various machine learning techniques to augment a set of candidate data objects 406 with one or more predictive insights. These insights may empower a selective messaging scheme for limiting network communications to/from a remote verification platform 416 based on a predictive likelihood of a positive outcome for a data object. By doing so, network communications between a prediction framework 410 and a remote verification platform 416 may be reduced, while improving a timing of a verification response for a data object. Ultimately, this reduction in time to verification may enable the initiation of prediction-based actions to retroactively address a selected and verified data object using a recovery model 420 traditionally limited to data mining approaches for post-action data analysis.

In some embodiments, a set of candidate data objects 406 are identified from the object data store 402 for the prediction framework 410. In some examples, the object data store 402 may be include a remote data store that is accessible to prediction framework 410. In such a case, the set of candidate data objects 406 may be extracted from the object data store 402, via an API 412, communicatively connecting the prediction framework 410 to the object data store 402.

In some embodiments, the object data store 402 is a data structure that describes a plurality of data objects for a prediction domain. An example object data store 402 may include any type (and any number) of data storage structures including, as examples, one or more linked lists, databases (e.g., relational databases, graph database, etc.), and/or the like. In some embodiments, the object data store 402 may include a plurality of data objects, each reflective of an interaction between two entities within the prediction domain. In some examples, the object data store 402 may correspond to a particular platform. For instance, the object data store 402 may include a plurality of data objects that are reflective of interactions between entities associated with a particular platform within the prediction domain.

In some embodiments, a data object is a data entity that describes a component (e.g., data record, node, etc.) of the object data store 402. A data object, for example, may include a historical record that records one or more attributes of a historical interaction within a prediction domain. In some examples, a data object may include one or more object attributes, predictive features, and/or the like, that may be leveraged by one or more techniques of the present disclosure to generate predictive insights for a prediction domain.

The information recorded by a data object may depend on the prediction domain. As an example, a data object may correspond to a medical claim in a clinical prediction domain. For example, a data object may include a medical record that describes one or more characteristics of a clinical interaction. In some examples, each data object may include a value transfer (e.g., a claim reimbursement, etc.) from a particular platform (e.g., an insurance platform) to a provider (e.g., a healthcare provider, etc.) associated with a medical claim. In this respect, the one or more attributes of the data object may be assessed to predict a likelihood of recovery for at least a portion of the value transfer by coordinating the value transfer across multiple platforms co-affiliated with the data object.

In some embodiments, an object attribute is a data entity that describes a characteristic of a data object. An object attribute, for example, may include a parameter, feature, and/or the like that describes a recorded aspect of a historical record. An object attribute may include a predictive feature, an object status, a value parameter, a predicted recovery parameter, a prediction entity identifier, a primary platform identifier, a secondary platform identifier, and/or any other type of characteristic for a data object.

In some embodiments, a predictive feature is an object attribute that is predictive of an outcome for a prediction domain. For example, a predictive feature may include an engineered and/or extracted object attribute that is weighted (e.g., by a machine learning model, etc.) as relevant to an outcome. A predictive feature, for example, may include an input to a machine learning model, such as the one or more models of the present disclosure, which is at least partially determinative of an output by the model. A predictive feature may depend on a prediction domain. As one example, in a clinical prediction domain for predicting a likelihood of recovery for a medical claim, a predictive feature may include a provider identifier (e.g., identifying a healthcare provided issuing a medical claim), a location identifier (e.g., a jurisdiction, district, state, relative location to a designated location, etc.), a timing identifier (e.g., a time of service, etc.), and/or one or more other claim attributes that may have a observed impact on a recovery outcome for a medical claim.

In some embodiments, a prediction entity is an object attribute that describes an entity associated with a data object. By way of example, a prediction entity may identify a member of a particular platform that is associated with the data object. As an example, in a clinical domain, the prediction entity may identify a patient that receives healthcare services during a clinical interaction recorded by a data object.

In some embodiments, an object status is an object attribute that describes a state of the data object within a prediction domain. For example, an object status may be one of a plurality of predefined object states that respectively describe a condition of a data object with respect to the prediction domain. The predefined object states, for example, may reflect a status of data object with respect to a value sharing process. By way of example, an object status may include a pending status (e.g., indicating that a value transfer has not yet been performed, etc.), a completed status (e.g., indicating that a value transfer has been performed, etc.), a closed status (e.g., indicating that a recovery time period has elapsed, etc.), an appealed status (e.g., indicating that an appeal process has been initiated, etc.), and/or the like. In some examples, an object status for a data object may be modified over time to track the condition of the data object as it progresses through a value sharing process.

In some embodiments, a predicted recovery parameter is an object attribute that describes a predicted recovery value for a data object. For example, a predicted recovery parameter may include a predicted value that is derived from a value parameter of a data object. By way of example, a value parameter may describe a requested value transfer, such as a claimed amount for a clinical procedure, etc., for the data object and the predicted recovery parameter may be a proportion (e.g., 1, .9, .5, . 3, etc.) of the value parameter. In a COB use case, for example, a value parameter may reflect a coverage value of a claim and a predicted recovery parameter may reflect an estimated contribution of a secondary platform.

In some embodiments, the set of candidate data objects 406 is identified from the object data store 402 using a pre-filtering rule set 404. For example, the object data store 402 may include a plurality of data objects that are respectively associated with one or more prediction entities. The set of candidate data objects 406 may be identified from the object data store 402 by identifying a target prediction entity based on one or more exclusionary entity statuses defined by the pre-filtering rule set 404. In some examples, one or more candidate data objects are identified that correspond to the target prediction entity. A candidate data object from the one or more candidate data objects may be added to the set of candidate data objects 406 based on a comparison between an object status of the candidate data object and an eligibility status defined by the pre-filtering rule set 404.

In some embodiments, the pre-filtering rule set 404 is a data entity that describes criteria for filtering data objects from an object data store. A pre-filtering rule set 404 may be configured to identify data objects that may be retroactively processed, via the prediction framework 410, to generate and act on one or more retroactive insights. In some examples, the pre-filtering rule set 404 may define criteria to filter out scenarios where the prediction framework 410 should not be applied in order to optimize the allocation of computing resources to high return scenarios. For example, the criteria may filter out data objects that (i) are subject to one or more other, superseding predictive processes and/or (ii) fail to satisfy one or more preliminary requirements of the prediction framework 410 to generate the set of candidate data objects 406. In this way, a robust dataset, such as the object data store 402, may be filtered to reduce a size of the set of candidate data objects 406 for the application of real-time, complex, prediction frameworks, such as the prediction framework 410 of the present disclosure that leverages a machine learning prioritization model 408 in combination with a sequence of pre- and post-processing techniques to generate individualized insights for a candidate data object.

In some examples, the pre-filtering rule set 404 may be tailored to a particular process, such as a COB investigation process, and may be dynamically updated based on one or more insights of the particular process. In some examples, the pre-filtering rule set 404 may define one or more exclusionary statuses for a particular process. The exclusionary statuses may correspond to a prediction entity of a data object. In this manner, a plurality of data objects may be filtered based the characteristics of a plurality of prediction entities respectively corresponding to the data objects. In addition, or alternatively, the pre-filtering rule set 404 may define a target attribute for a data object. By way of example, the pre-filtering rule set 404 may define (i) one or more exclusionary entity statuses for identifying one or more target prediction entities that are respectively associated with one or more data objects and (ii) an eligibility status for identifying the set of candidate data objects 406 from the one or more data objects.

In some embodiments, an exclusionary entity status is a configurable data parameter that describes an entity status of a target prediction entity for the prediction framework 410. An exclusionary entity status, for example, may include one or more predefined entity states that respectively describe a candidate condition of a prediction entity. The predefined object states, for example, may reflect a status of prediction entity with respect to a value sharing process (e.g., a COB process, etc.).

In some examples, a first exclusionary entity status may include a pending investigation status indicating that a prediction entity has not been investigated for the value sharing process. A second exclusionary entity status may include a priority pending investigation state indicating that a prediction entity has been identified for investigation but has not been investigated for the value sharing process. A third exclusionary entity status may include a failed investigated state indicating that the prediction entity has been investigated and does not comply with a value sharing process. A fourth exclusionary entity status may include a probable pending investigation state indicating that a prediction entity has a probability for complying with a value sharing process but has not been investigated for the value sharing process.

In some examples, the exclusionary entity status may be applied to a plurality of prediction entities to identify one or more target prediction entities that do comply with the exclusionary entity statuses (e.g., no not fall into the exclusions defined by the exclusionary entity statuses). The target prediction entities, for example, may include an accepted value sharing status indicating that the prediction entities have been investigated and do comply with a value sharing process.

In some embodiments, an eligibility status is a configurable data parameter that describes an object status of a data object for the prediction framework 410. In some examples, the eligibility status may include a completed status indicating that a value transfer has been performed and that the data object is not closed or appealed.

In some embodiments, the set of candidate data objects 406 includes one or more data objects from the object data store 402 that are candidates for the prediction framework 410. A set of candidate data objects may include any number of candidate objects, from the object data store 402, that comply with the pre-filtering rule set 404. For example, each of the candidate data objects of a set of candidate data objects 406 may be filtered from the object data store 402 based on the one or more exclusionary entity statuses and/or eligibility statuses associated with the candidate data objects (and/or a prediction entity associated therewith).

The set of candidate data objects may include one or more different data types based on the prediction domain. In one example, for a clinical COB domain, the set of candidate data objects 406 may include one or more paid medical claims for members that are flagged for potentially having coverage with a second insurance provider. In this way, a set of paid claims may be injected as an initial input to the prediction framework 410 to retroactively recover a value transfer based on a value sharing process.

In some examples, a secondary platform may be predicted for each of the candidate data objects of the set of candidate data objects 406. The secondary platform, for example, may be predicted for each of the candidate data objects based on one or more object attributes (e.g., one or more demographic attributes, claim attributes, etc.). In some examples, the secondary platform may be predicted by one or more prediction models 418. The prediction models 418, for example, may include a rule-based and/or machine learning model configure, trained, and/or the like to generate a secondary platform prediction based on one or more object attributes of a data object. The one or more prediction models 418 may include a single model and/or a plurality of models tailored for a specific data object type, a secondary platform, and/or the like. In some examples, the prediction models 418 may be trained, configured, and/or the like by a computing entity and then accessed by the prediction framework 410 to generate the secondary platform predictions for the set of candidate data objects 406. Once generated, the secondary platform predictions may be stored as an additional attribute with each data object of the set of candidate data objects 406.

In this manner, each candidate data object of the set of candidate data objects 406 may be processed in accordance with the prediction framework 410 to generate one or more recovery insights for prioritizing the candidate data objects with respect to other candidate data objects. In some examples, the prediction framework 410 may include a plurality of sequential models for sequentially generating different insights for the set of candidate data objects 406. For example, the prediction framework 410 may include a machine learning prioritization model 408 that is continuously trained to generate composite recovery scores for the set of candidate data objects 406.

In some embodiments, the plurality of composite recovery scores is generated for the set of candidate data objects 406. For example, the composite recovery scores may be generated using the machine learning prioritization model 408. The machine learning prioritization model 408, for example, may include a decision tree classifier that is trained to generate a composite recovery score based on one or more predictive features of a data object.

In some embodiments, the machine learning prioritization model 408 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning prioritization model 408 may include any type of model configured, trained, and/or the like to generate a composite recovery score, as described herein. The machine learning prioritization model 408 may include one or more of any type of machine learning model including one or more supervised, unsupervised, semi-supervised, and/or reinforcement learning models. In some embodiments, the machine learning prioritization model 408 may include multiple models configured to perform one or more different stages of a prioritization process.

In some embodiments, the machine learning prioritization model 408 includes a decision tree architecture, such as a classification decision tree, a regression decision tree, and/or the like. By utilizing a decision tree architecture, the machine learning prioritization model 408 may improve explainability with respect to a prioritization process. In some examples, the decision tree architecture may be trained, using one or more supervisory training techniques, such as back-propagation of errors, to optimize a recovery loss function. The recovery loss function, for example, may include a Gini impurity index, mean square error, Chi square measure, and/or the like. In some examples, the recovery loss function may be applied to a plurality of training outputs generated using a recovery training store 432. As described herein, the recovery training store 432 may include a plurality of historical data object pairs with a plurality of recovery labels. The machine learning prioritization model 408 may be trained to generate composite recovery predictions based on a correspondence between the plurality of training outputs and the plurality of recovery labels of the plurality of historical data object pairs.

In some embodiments, a composite recovery score is an output of the machine learning prioritization model 408. A composite recovery score may include a value that is reflective of a likelihood of a positive label category for a data object. In some examples, a composite recovery score may include a number between 0 and 1. In addition, or alternatively, a composite recovery score may include a ratio, percentage, and/or a binary and/or real number output reflective of a predicted recovery outcome for an input data object. In some examples, a composite recovery score represents a likelihood that an input data object (e.g., a medical claim in a clinical domain) may be recovered in response to the application of the prediction framework 410. A composite recovery score, for example, may be an inverse of a combined probability that a data object (e.g., medical claim) is closed and/or appealed before and/or after recovery.

In some embodiments, the machine learning prioritization model 408 is continuously trained using the recovery training store 432. For example, the recovery training store 432 may be accessed to perform one or more training operations. The recovery training store 432 may include a plurality of historical data object pairs. The plurality of historical data object pairs may include a plurality of historical data objects and a plurality of recovery labels that identify a plurality of recovery outcomes respectively corresponding to the plurality of historical data objects. In some examples, a plurality of training outputs may be generated, using an untrained (e.g., initial, etc.) machine learning prioritization model 408, based on the plurality of historical data objects. One or more parameters of the untrained machine learning prioritization model 408 may be updated, using backpropagation of errors, based on a comparison between the plurality of training outputs to the plurality of recovery labels to generate a trained machine learning prioritization model 408.

In some embodiments, the recovery training store 432 is a data structure that describes a plurality of training data objects for a prediction domain. An example recovery training store 432 may include any type (and any number) of data storage structures including, as examples, one or more linked lists, databases (e.g., relational databases, graph database, etc.), and/or the like. In some embodiments, the recovery training store 432 may include a plurality of historical data object pairs. The plurality of historical data object pairs may include one or more historical, synthetic, and/or simulated data objects that are stored, generated, and/or simulated for training a machine learning model, providing compliance records for recovery decisions, and/or the like. In some examples, the historical data object pairs may include one or more historical data objects from the object data store 402. For example, the recovery training store 432 may be augmented with data objects from the object data store 402 after an elapsed time period from an event (e.g., payment event, recovery event, closure event, etc.).

In some embodiments, the recovery training store 432 includes one or more predictive features for each of a plurality of historical data object pairs. The predictive features, for example, may include one or more entity attributes (e.g., prediction entity attributes, etc.) associated with an entity corresponding to a historical data object. In some examples, the predictive features may be domain specific. For instance, in a clinical domain, the recovery training store 432 may include a plurality of historical medical claims labeled with one or more claim recovery outcomes. In such a case, additional predictive features may include patient profiles, provider profiles, and/or the like of one or more members and/or providers associated with each medical claim. By way of example, a historical data object pair of the plurality of historical data object pairs may correspond to a historical medical claim and a claim label for the historical medical claim. The claim label may include a binary label that identifies a positive label category and/or a negative label category for the historical medical claim. The positive label category may indicate that the historical medical claim resulted in a claim recovery. The negative label category may indicate that the historical medical claim resulted in either (a) a claim closure without the claim recovery or (b) an appeal to the claim recovery.

More particularly, in some embodiments, a historical data object pair is a component of the recovery training store 432 that describes a training entry for a machine learning model. A historical data object pair, for example, may include a historical, synthetic, and/or simulated data object and a recovery label corresponding to the data object. A historical data object pair may be domain specific. For example, in a clinical domain, a historical data object pair may include the medical claim with a recovery label identifying a recovery outcome for the medical claim, as described herein.

In some embodiments, a recovery label is a data entity that describes a training label for a training data object. A recovery label may describe a historical, synthetic, and/or simulated outcome for a corresponding data object. A recovery label, for example, may include a positive label category and/or a negative label category that respectively describe one or more categories of outcomes for a data object. The positive and negative label categories may define a binary classification label by breaking a complex set of outcomes into a positive and negative classification. For instance, a positive label category may include a plurality of different positive outcomes that are each reflective of a positive overall effect (e.g., conversion of processing resources to value gain, etc.) of applying the prediction framework 410 to a data object. A negative label category may include a plurality of different negative outcomes that are each reflective of a negative overall effect (e.g., waste of processing resources, etc.) of applying the prediction framework 410 to a data object.

A recovery label may be domain specific. As an example, in a clinical domain, a positive label category may include a claim recovery for a medical claim, whereas a negative label category may include a claim closure before a claim recovery and/or an appeal after a claim recovery for a medical claim.

In some embodiments, a prioritized ranking data structure 414 is generated for the set of candidate data objects 406 based on the plurality of composite recovery scores. In some examples, the prioritized ranking data structure 414 may be generated by generating a filtered set of candidate data objects and then ranking the filtered set of candidate data objects. The filtered set of candidate data objects, for example, may be generated by filtering the set of candidate data objects 406 based on a comparison of the plurality of composite recovery scores with a tiered recovery score threshold. For example, a candidate data object of the set of candidate data objects 406 may be associated with a composite recovery score and a predicted recovery parameter. The tiered recovery score threshold may define a plurality of composite recovery score thresholds respectively corresponding to a plurality of predicted recovery parameter ranges. In some examples, the candidate data object may be ranked based on a comparison of the composite recovery score to the predicted recovery parameter.

In some embodiments, the prioritized ranking data structure 414 is a data structure that describes a prioritized set of candidate data objects 406 for a resource intensive recovery process. A prioritized ranking data structure 414 includes one or more data objects from the set of candidate data objects 406 that are filtered and ranked based on their composite recovery scores. For example, the prioritized ranking data structure 414 may be generated by comparing the composite recovery scores to a tiered recovery score threshold. The prioritized ranking data structure 414 may include each of the data objects that satisfy the tiered recovery score threshold. In some examples, the data objects of the prioritized ranking data structure 414 may be ranked based on their composite recovery scores to efficiently assign limited computing resources to data objects with the highest relative likelihoods of a positive outcome. In some examples, a relative likelihood may include a composite recovery score that is weighted by a predicted recovery parameter for the data object.

In some embodiments, the tiered recovery score threshold is a configurable tiered threshold parameter that describes criteria for a resource intensive recovery process. The tiered recovery score threshold may define a plurality of composite recovery score thresholds for a recovery process. Each of the plurality of composite recovery score thresholds may correspond to a predicted recovery parameter range. In some examples, the composite recovery score thresholds may include escalating thresholds relative to decreasing predicted recovery parameter ranges. In this manner, the tiered recovery score threshold may enforce a higher composite recovery score the lower the predicted recovery parameter is. By way of example, the tiered recovery score threshold may include first threshold for a first recovery parameter range and a higher, second threshold for a second recovery parameter range that is lower than the first recovery parameter range.

In some embodiments, a verification request is provided to a remote verification platform 416 for a selected data object of the set of candidate data objects 406 based on the prioritized ranking data structure 414. In some examples, the remote verification platform 416 may be an intermediary server configured to process the verification request in response to a value transfer.

In some embodiments, the remote verification platform 416 is a computing system associated with a verification platform. A remote verification platform 416, for example, may include an example computing entity, including one or more processors and/or memory storing instructions that, when executed by the one or more processors, cause the computing entity to perform one or more operations described herein. In some examples, a remote verification platform 416 may include at least a portion of a cloud server that is accessible to another computing entity. By way of example, in a clinical network domain, a remote verification platform 416 may include a computing entity that is accessible by an insurance platform for verifying information for a medical claim at a cost to the insurance platform. By way of example, a remote verification platform 416 may include a clearinghouse 270/271 that may be paid to identify coverage details for a patient, a healthcare provider, and/or for a specific medical claim.

In some embodiments, a verification request is a data entity that describes a communication to a remote verification platform 416. A verification request may include one or more API-based messages that may be provided to the remote verification platform 416 through a platform-platform interface, such as the API 412. In some examples, a verification request may include a request to confirm one or more predicted and/or observed object attributes for a data object. The object attributes may depend on a prediction domain. In a clinical prediction domain, the verification request may include a request to confirm (1) an identify of a secondary platform for a data object, (2) the time range of overlapping coverages between a primary and secondary platform, and/or (3) a coverage type of the secondary platform.

In some embodiments, a prediction-based action is initiated for the selected data object in response to a verification response from the remote verification platform 416. For example, a time range for the selected data object may be received from the remote verification platform 416. In some examples, the selected data object may be verified based on a comparison between a timing parameter of the selected data object to the time range. By way of example, the comparison may confirm that a data of service of the data object overlaps with a service time period associated with an identified secondary platform.

In some embodiments, the verification response is a data entity that describes a communication from the remote verification platform 416. The verification response may include one or more API-based messages that may be received from the remote verification platform 416 through a platform-platform interface, such as the API 412. In some examples, the verification response may include a response to a verification request. For example, the verification response may confirm one or more object attributes for a data object. The object attributes may depend on a prediction domain. In a clinical prediction domain, the verification response may include a response to confirm (1) the identify of a secondary platform for a data object, (2) the time range of overlapping coverages between a primary and secondary platform, and/or (3) the coverage type of the secondary platform.

In some embodiments, the initiated prediction-based action is a recovery action responsive to a detection of a predicted recovery outcome. A prediction-based action may include any of a plurality of different computing tasks and/or actions to initiate a recovery outcome. In some examples, a prediction-based action may be performed in response to a verification response verifying that a data object is associated with an overlapping range of coverage between a primary and secondary platform. In such a case, a prediction-based action may include an automated recovery notification process in which a recovery notification 422 is generated and provided to a secondary platform (e.g., via a provider device 424, etc.). In addition, or alternatively, a prediction-based action may include a providing one or more computing instructions to a client device (e.g., a provider device 424, user device, etc.) to initiate a notification, via one or more displays, vibration actuators, and/or the like. In this manner, a physical action may be performed to initiate a recovery outcome for a data object. In some embodiments, a prediction-based action may be initiated by the recovery model 420 that is communicatively connected to the prediction framework 410 via an API 412.

In some embodiments, a selected data object is provided to the recovery model 420. The recovery model 420 may be configured to identify a provider entity associated with the selected data object. The recovery model 420 may generate a recovery notification 422 for the selected data object and provide the recovery notification 422 to a provider device 424 associated with the provider entity.

In some embodiments, a recovery model 420 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The recovery model 420 may include any type of model configured, trained, and/or the like to initiate a prediction-based action in response to a detection of a predicted recovery outcome. For example, the recovery model 420 may include a data mining model configured to automatically generate the recovery notification 422 and provide the recovery notification 422 to a provider associated with the data object.

In some examples, the recovery model 420 may include a generative model configured to generate natural language text from a data object. For example, the generative model may include a large language model (LLM), such as a generative pre-trained transformer (GPT) model. In some examples, the generative model may include a GPT-4 model and/or any other machine learning model with generative text capabilities. The generative model may be configured to automatically generate the recovery notification 422 based on a generative prompt (e.g., a few shot prompt with one or more notification examples, etc.) identifying the data object and/or one or more object attributes thereof.

In some examples, a recovery model 420 may include a model-provider interface for facilitating communication between the recovery model 420 and one or more provider systems. In some examples, the model-provider interface may include an API that defines communications between the recovery model 420 and the one or more provider systems. In some examples, a recovery notification 422 may be provided to a provider device 424 via the model-provider interface.

In some examples, the recovery model 420 may monitor a recovery operation for a data object to identify a recovery outcome. In response to a recovery outcome, the recovery outcome may store the recovery outcome in the recovery training store 432. In this manner, the recovery outcome may be leveraged to generate a historical data object pair to continuously retrain a machine learning model, such as the machine learning prioritization model 408. In some examples, in response to a negative recovery outcome, a prediction entity may be monitored to identify one or more information changes in a data object profile. In response to a detected change, the data object may be reanalyzed using the prediction framework 410 of the present disclosure.

In some embodiments, the recovery notification 422 to a data entity that describes generative text that is output by the recovery model 420 responsive to a potential positive recovery outcome. The recovery notification 422 may depend on a prediction domain. By way of example, in a clinical domain, the recovery notification 422 may include an overpayment letter that may request a recovery operation by a provider associated with a medical claim.

As described herein, the selected data object may be stored in the recovery training store 432 as a historical data object. In some examples, recovery data may be received for the historical data object. The recovery data, for example, may identify a recovery response to a request for reimbursement for a medical claim. A recovery label may be generated for the historical data object based on the recovery data. For example, a negative label category may be generated in response to a recovery response that identifies a recovery appeal or a claim closure without a claim recovery. In addition, or alternatively, a positive label category may be generated in response to a recovery response that identifies a completed claim recovery and an expiration of an appeal deadline for the historical data object. In some examples, the machine learning prioritization model 408 may be continuously retrained based on the historical data object and the recovery label.

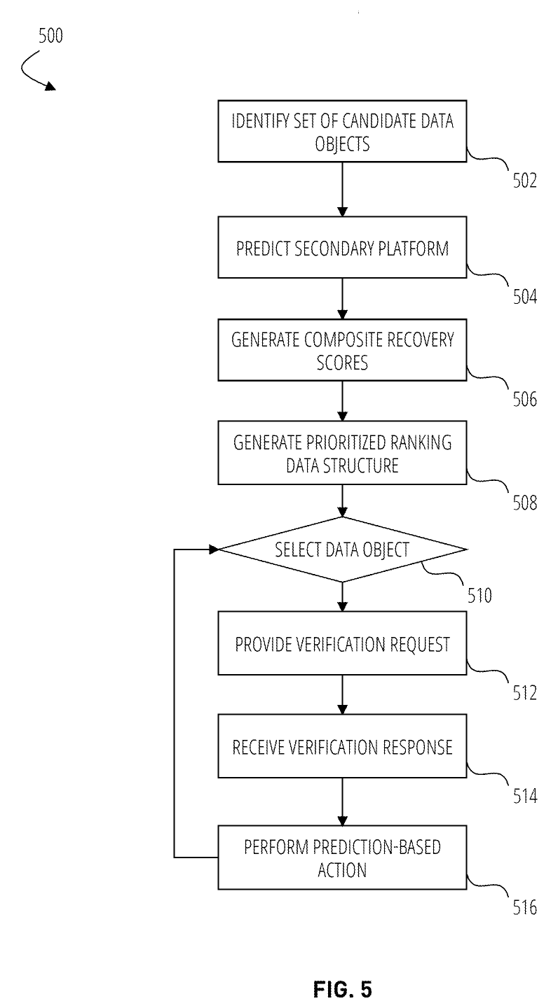

FIG. 5 is a flowchart diagram of an example retroactive prediction process 500 in accordance with some embodiments discussed herein. The flowchart depicts a multi-stage data filtering process 500 for improving processing resource allocation and network messaging techniques. The process 500 may be implemented by one or more computing devices, entities, and/or systems described herein. For example, via the various steps/operations of the process 500, the computing system 101 may leverage improved resource allocation and network messaging techniques to sequentially filter data objects from a large dataset for a staged prediction-based action. By doing so, the process 500 reduces the time and expense of processing large datasets, which results in broader coverage of a robust dataset while enabling near real time, retroactive, remedial actions to address predictive insights across the robust dataset. In this way, the process 500 leverages a new prediction framework to improve processing resource allocation and processing times for a robust dataset that ultimately enable remedial actions traditionally unavailable due to technical challenges with traditional data processing techniques.

FIG. 5 illustrates an example process 500 for explanatory purposes. Although the example process 500 depicts a particular sequence of steps/operations, the sequence may be altered without departing from the scope of the present disclosure. For example, some of the steps/operations depicted may be performed in parallel or in a different sequence that does not materially impact the function of the process 500. In other examples, different components of an example device or system that implements the process 500 may perform functions at substantially the same time or in a specific sequence.

In some embodiments, the process 500 includes, at step/operation 502, identifying a set of candidate data objects. For example, a computing system 101 may identify, using a pre-filtering rule set, a set of candidate data objects from an object data store. For instance, the object data store may include a plurality of data objects that are respectively associated with one or more prediction entities.

In some examples, the computing system 101 may identify a target prediction entity based on one or more exclusionary entity statuses defined by the pre-filtering rule set. The computing system 101 may identify one or more candidate data objects corresponding to the target prediction entity and add a candidate data object of the one or more candidate data objects to the set of candidate data objects based on a comparison between an object status of the candidate data object and an eligibility status defined by the pre-filtering rule set.

In some embodiments, the process 500 includes, at step/operation 504, predicting a secondary platform for each data object of the set of candidate data objects. For example, a computing system 101 may generate, using one or more predictive models, a secondary platform prediction based on one or more object attributes of the data object. The secondary platform prediction may be stored as an additional object attribute for the data object.

In some embodiments, the process 500 includes, at step/operation 506, generating composite recovery scores for the set of candidate data objects. For example, a computing system 101 may generate, using a machine learning prioritization model, a plurality of composite recovery scores for the set of candidate data objects. The machine learning prioritization model, for example, may include a decision tree classifier that is trained to generate a composite recovery score based on one or more predictive features of a data object.

In some examples, the machine learning prioritization model may be trained by receiving a recovery training store that includes a plurality of historical data object pairs. The plurality of historical data object pairs may include a plurality of historical data objects and a plurality of recovery labels that identify a plurality of recovery outcomes respectively corresponding to the plurality of historical data objects. A plurality of training outputs may be generated, using an untrained machine learning prioritization model, based on the plurality of historical data objects. A trained machine learning prioritization model may be trained by updating, using backpropagation of errors, one or more parameters of the untrained machine learning prioritization model based on a comparison between the plurality of training outputs to the plurality of recovery labels to generate a trained machine learning prioritization model.

In some embodiments, a historical data object pair of the plurality of historical data object pairs corresponds to a historical medical claim and a claim label for the historical medical claim. The claim label may include a binary label that identifies a positive label category or a negative label category for the historical medical claims. In some examples, a positive label category may indicate that the historical medical claim resulted in a claim recovery. In some examples, a negative label category may indicative that the historical medical claim resulted in either (a) a claim closure without the claim recovery or (b) an appeal to the claim recovery.

In some embodiments, the process 500 includes, at step/operation 508, generating a prioritized ranking data structure for the set of candidate data objects. For example, a computing system 101 may generate a prioritized ranking data structure for the set of candidate data objects based on the plurality of composite recovery scores. In some examples, the computing system 101 may generate a filtered set of candidate data objects by filtering the set of candidate data objects based on a comparison of the plurality of composite recovery scores with a tiered recovery score threshold. The computing system 101 may generate the prioritized ranking data structure by ranking the filtered set of candidate data objects.

In some examples, a candidate data object is ranked based on a comparison of the composite recovery score to a predicted recovery parameter. For example, a candidate data object of the set of candidate data objects may be associated with a composite recovery score and a predicted recovery parameter. The tiered recovery score threshold may define a plurality of composite recovery score thresholds respectively corresponding to a plurality of predicted recovery parameter ranges.

In some embodiments, the process 500 includes, at step/operation 510, selecting a data object based on the prioritized ranking data structure. For example, a computing system 101 may select the data object in accordance with a ranking of the prioritized ranking data structure.

In some embodiments, the process 500 includes, at step/operation 512, providing a verification request for the selected data object. For example, a computing system 101 may provide, to a remote verification platform, a verification request for a selected data object of the set of candidate data objects based on the prioritized ranking data structure. The remote verification platform, for example, may include an intermediary server configured to process the verification request in response to a value transfer.

In some embodiments, the process 500 includes, at step/operation 514, receiving a verification response from the remote verification platform. For example, a computing system 101 may receive the verification response from the remote verification platform. In some examples, the computing system may receive a time range for the selected data object from the remote verification platform and verify the selected data object based on a comparison between a timing parameter of the selected data object to the time range.

In some embodiments, the process 500 includes, at step/operation 516, perform a prediction-based action based on the verification response. For example, a computing system 101 may, responsive to the verification response from the remote verification platform, initiate a prediction-based action for the selected data object.

In some embodiments, the process 500 may return to step/operation 510 to select another data object based on the prioritized ranking data structure. In some examples, the process 500 may perform a plurality of iterations of step/operations 510 to 516 until an end condition is satisfied. The end condition, for example, may include a threshold number of verification requests (e.g., within a time period, etc.), a portion of the prioritized ranking data structure that is verified and/or unverified, and/or any other configurable metric for optimizing a processing resource allocation for the process 500.

Some techniques of the present disclosure enable the generation of action outputs that may be performed to initiate one or more real world actions to achieve real-world effects. The processing resource allocation and network messaging techniques of the present disclosure may be used, applied, and/or otherwise leveraged to collaboratively process messages, which may help in the resolution of data object within complex prediction domains. The resolution of data objects may trigger the performance of various computing tasks that improve the performance of a computing system (e.g., a computer itself, etc.) with respect to various actions performed by the computing system 101. Example actions may include the display, transmission, and/or the like of data reflective of data object resolution, such as alerts of a recovery outcome for a member, and/or the like. Moreover, the actions may include physical actions, such as an allocation of currency, mailing of a physical letter, and/or the like, that may be triggered in response to the resolution of a data object.

In some examples, the computing tasks may include actions that may be based on a prediction domain. A prediction domain may include any environment in which computing systems may be applied to communicate messages and initiate the performance of computing tasks responsive to the messages. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

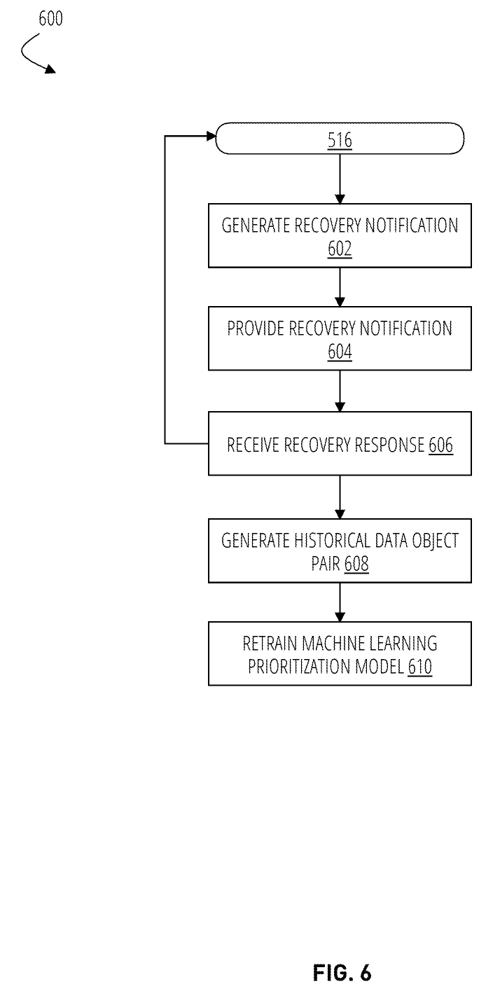

FIG. 6 is a flowchart diagram of an example machine learning training process 600 in accordance with some embodiments discussed herein. The flowchart depicts a retroactive recovery and subsequent retraining process 600 for continuously tailoring and improving a machine learning model with respect to the retroactive recovery process. The process 600 may be implemented by one or more computing devices, entities, and/or systems described herein. For example, via the various steps/operations of the process 600, the computing system 101 may leverage improved model training techniques to initiate and monitor recovery processes and continuously retrain a model based on insights from the recovery processes. By doing so, the process 600 facilitates an adaptable recovery process that is directly tailored to addressing technical challenges of traditional machine learning technologies that suffer from model data drift and other performance deficiencies.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 may begin at step/operation 516 of the process 500, where the process 500 includes performing a prediction-based action. By way of example, the process 600 may include one or more steps/operations for initiating a performance an example prediction-based action.

In some embodiments, the process 600 includes, at step/operation 602, generating a recovery notification. For example, a computing system 101 may provide a selected data object to a recovery model configured to identify a provider entity associated with the selected data object, generate a recovery notification for the selected data object; and provide the recovery notification to the provider entity.

In some embodiments, the process 600 includes, at step/operation 604, providing a recovery notification. For example, the computing system 101 may provide, using the recovery model, the recovery notification to the provider entity.

In some embodiments, the process 600 includes, at step/operation 606, receiving a notification response. For example, a computing system 101 may receive the notification response from the provider entity. The notification response may include recovery data associated with the recovery notification. For example, the recovery data may identify a recovery response to a request for reimbursement for a medical claim.

In some examples, the process 600 may return to step/operation 516 of process 500 to perform a prediction-based action for another verified data object. In addition, or alternatively, the process 600 may proceed to step/operation 608 to generate training data for a machine learning model.

In some embodiments, the process 600 includes, at step/operation 608, generating historical data object pair. For example, a computing system 101 may store the selected data object in a recovery training store as a historical data object. The computing system 101 may receive recovery data for the historical data object and generate a recovery label for the historical data object based on the recovery data. For example, the computing system 101 may generate a negative label category in response to a recovery response that identifies a recovery appeal or a claim closure without a claim recovery. In addition, or alternatively, the computing system 101 may generate a positive label category in response to a recovery response that identifies a completed claim recovery and an expiration of an appeal deadline for the historical data object. The computing system 101 may generate the historical data object pair based on the historical data object and the recovery label.

In some embodiments, the process 600 includes, at step/operation 610, retraining a machine learning prioritization model using the historical data object pair. For example, a computing system 101 may retrain the machine learning prioritization model based on the historical data object and the recovery label.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising identifying, by one or more processors and using a pre-filtering rule set, a set of candidate data objects from an object data store; generating, by one or more processors using a machine learning prioritization model, a plurality of composite recovery scores for the set of candidate data objects; generating, by the one or more processors, a prioritized ranking data structure for the set of candidate data objects based on the plurality of composite recovery scores; providing, by the one or more processors and to a remote verification platform, a verification request for a selected data object of the set of candidate data objects based on the prioritized ranking data structure; and responsive to a verification response from the remote verification platform, initiating, by the one or more processors, a prediction-based action for the selected data object.

Example 2. The computer-implemented method of example 1, wherein the machine learning prioritization model comprises a decision tree classifier that is trained to generate a composite recovery score based on one or more predictive features of a data object.

Example 3. The computer-implemented method of example 2, wherein the machine learning prioritization model is trained by receiving a recovery training store comprising a plurality of historical data object pairs, wherein the plurality of historical data object pairs comprises a plurality of historical data objects and a plurality of recovery labels that identify a plurality of recovery outcomes respectively corresponding to the plurality of historical data objects; generating, using an untrained machine learning prioritization model, a plurality of training outputs based on the plurality of historical data objects; and updating, using backpropagation of errors, one or more parameters of the untrained machine learning prioritization model based on a comparison between the plurality of training outputs to the plurality of recovery labels to generate a trained machine learning prioritization model.

Example 4. The computer-implemented method of example 3, wherein (i) a historical data object pair of the plurality of historical data object pairs corresponds to a historical medical claim and a claim label for the historical medical claim, (ii) the claim label is a binary label that identifies a positive label category or a negative label category for the historical medical claims, (iii) the positive label category indicates that the historical medical claim resulted in a claim recovery, and (iv) the negative label category indicates that the historical medical claim resulted in either (a) a claim closure without the claim recovery or (b) a recovery appeal to the claim recovery.

Example 5. The computer-implemented method of any of the preceding examples, wherein generating the prioritized ranking data structure for the set of candidate data objects based on the plurality of composite recovery scores comprises generating a filtered set of candidate data objects by filtering the set of candidate data objects based on a comparison of the plurality of composite recovery scores with a tiered recovery score threshold; and generating the prioritized ranking data structure by ranking the filtered set of candidate data objects.

Example 6. The computer-implemented method of example 5, wherein a candidate data object of the set of candidate data objects is associated with a composite recovery score and a predicted recovery parameter and the tiered recovery score threshold defines a plurality of composite recovery score thresholds respectively corresponding to a plurality of predicted recovery parameter ranges.

Example 7. The computer-implemented method of example 6, wherein the candidate data object is ranked based on a comparison of the composite recovery score to the predicted recovery parameter.

Example 8. The computer-implemented method of any of the preceding examples, wherein the object data store comprises a plurality of data objects that are respectively associated with one or more prediction entities and identifying the set of candidate data objects from the object data store comprises identifying a target prediction entity based on one or more exclusionary entity statuses defined by the pre-filtering rule set; identifying one or more candidate data objects corresponding to the target prediction entity; and adding a candidate data object of the one or more candidate data objects to the set of candidate data objects based on a comparison between an object status of the candidate data object and an eligibility status defined by the pre-filtering rule set.

Example 9. The computer-implemented method of any of the preceding examples, wherein the remote verification platform is an intermediary server configured to process the verification request in response to a value transfer.

Example 10. The computer-implemented method of any of the preceding examples, further comprising receiving a time range for the selected data object from the remote verification platform; and verifying the selected data object based on a comparison between a timing parameter of the selected data object to the time range.

Example 11. The computer-implemented method of any of the preceding examples, wherein initiating the prediction-based action for the selected data object comprises providing the selected data object to a recovery model configured to identify a provider entity associated with the selected data object; generate a recovery notification for the selected data object; and provide the recovery notification to the provider entity.

Example 12. The computer-implemented method of any of the preceding examples, further comprising storing the selected data object in a recovery training store as a historical data object; receiving recovery data for the historical data object; generating a recovery label for the historical data object based on the recovery data; and retraining the machine learning prioritization model based on the historical data object and the recovery label.

Example 13. The computer-implemented method of example 12, wherein the recovery data identifies a recovery response to a request for reimbursement for a medical claim, and generating the recovery label comprises generating a negative label category when the recovery response identifies a recovery appeal or a claim closure without a claim recovery, or generating a positive label category when the recovery response identifies a completed claim recovery and an expiration of an appeal deadline for the historical data object.

Example 14. A computing system comprising memory and one or more processors communicatively coupled to the memory, the one or more processors configured to identify, using a pre-filtering rule set, a set of candidate data objects from an object data store; generate, using a machine learning prioritization model, a plurality of composite recovery scores for the set of candidate data objects; generate a prioritized ranking data structure for the set of candidate data objects based on the plurality of composite recovery scores; provide, to a remote verification platform, a verification request for a selected data object of the set of candidate data objects based on the prioritized ranking data structure; and responsive to a verification response from the remote verification platform, initiating a prediction-based action for the selected data object.

Example 15. The computing system of example 14, wherein the machine learning prioritization model comprises a decision tree classifier that is trained to generate a composite recovery score based on one or more predictive features of a data object.

Example 16. The computing system of example 15, wherein the machine learning prioritization model is trained by receiving a recovery training store comprising a plurality of historical data object pairs, wherein the plurality of historical data object pairs comprises a plurality of historical data objects and a plurality of recovery labels that identify a plurality of recovery outcomes respectively corresponding to the plurality of historical data objects; generating, using an untrained machine learning prioritization model, a plurality of training outputs based on the plurality of historical data objects; and updating, using backpropagation of errors, one or more parameters of the untrained machine learning prioritization model based on a comparison between the plurality of training outputs to the plurality of recovery labels to generate a trained machine learning prioritization model.

Example 17. The computing system of claim 16, wherein (i) a historical data object pair of the plurality of historical data object pairs corresponds to a historical medical claim and a claim label for the historical medical claim, (ii) the claim label is a binary label that identifies a positive label category or a negative label category for the historical medical claims, (iii) the positive label category indicates that the historical medical claim resulted in a claim recovery, and (iv) the negative label category indicates that the historical medical claim resulted in either (a) a claim closure without the claim recovery or (b) a recovery appeal to the claim recovery.

Example 18. The computing system of any of claims 14 through 17, wherein generating the prioritized ranking data structure for the set of candidate data objects based on the plurality of composite recovery scores comprises generating a filtered set of candidate data objects by filtering the set of candidate data objects based on a comparison of the plurality of composite recovery scores with a tiered recovery score threshold; and generating the prioritized ranking data structure by ranking the filtered set of candidate data objects.

Example 19. One or more non-transitory computer-readable storage media including instructions that, when executed by one or more processors, cause the one or more processors to identify, using a pre-filtering rule set, a set of candidate data objects from an object data store; generate, using a machine learning prioritization model, a plurality of composite recovery scores for the set of candidate data objects; generate a prioritized ranking data structure for the set of candidate data objects based on the plurality of composite recovery scores; provide, to a remote verification platform, a verification request for a selected data object of the set of candidate data objects based on the prioritized ranking data structure; and responsive to a verification response from the remote verification platform, initiating a prediction-based action for the selected data object.

Example 20. The one or more non-transitory computer-readable storage media of claim 19, wherein the instructions further cause the one or more processors to store the selected data object in a recovery training store as a historical data object; receive recovery data for the historical data object; generate a recovery label for the historical data object based on the recovery data; and retrain the machine learning prioritization model based on the historical data object and the recovery label.

Example 21. The computer-implemented method of example 1 further comprising receiving training data for the machine learning prioritization model; and training the machine learning prioritization model using the training data.

Example 22: The computer-implemented method of example 21, wherein the training is performed by the one or more processors.

Example 23: The computer-implemented method of example 21, wherein the one or more processors are included in a first computing entity; and the training is performed by one or more other processors included in a second computing entity.

Example 24. The computing system of example 14, wherein the one or more processors are further configured to receive training data for the machine learning prioritization model; and train the machine learning prioritization model using the training data.

Example 25: The computing system of example 24, wherein the training is performed by the one or more processors.

Example 26: The computing system of example 24, wherein the one or more processors are included in a first computing entity; and the training is performed by one or more other processors included in a second computing entity.

Example 27. The one or more non-transitory computer-readable storage media of example 19, wherein the one or more processors are further configured to receive training data for the machine learning prioritization model; and train the machine learning prioritization model using the training data.

Example 28: The one or more non-transitory computer-readable storage media of example 27, wherein the training is performed by the one or more processors.

Example 29: The one or more non-transitory computer-readable storage media of example 27, wherein the one or more processors are included in a first computing entity; and the training is performed by one or more other processors included in a second computing entity.

1. A computer-implemented method comprising:
identifying, by one or more processors and using a pre-filtering rule set, a set of candidate data objects from an object data store;
generating, by one or more processors using a machine learning prioritization model, a plurality of composite recovery scores for the set of candidate data objects; generating, by the one or more processors, a prioritized ranking data structure for the set of candidate data objects based on the plurality of composite recovery scores;
providing, by the one or more processors and to a remote verification platform, a verification request for a selected data object of the set of candidate data objects based on the prioritized ranking data structure; and
responsive to a verification response from the remote verification platform, initiating, by the one or more processors, a prediction-based action for the selected data object.

2. The computer-implemented method of claim 1, wherein the machine learning prioritization model comprises a decision tree classifier that is trained to generate a composite recovery score based on one or more predictive features of a data object.

3. The computer-implemented method of claim 2, wherein the machine learning prioritization model is trained by:
receiving a recovery training store comprising a plurality of historical data object pairs, wherein the plurality of historical data object pairs comprises a plurality of historical data objects and a plurality of recovery labels that identify a plurality of recovery outcomes respectively corresponding to the plurality of historical data objects;
generating, using an untrained machine learning prioritization model, a plurality of training outputs based on the plurality of historical data objects; and
updating, using backpropagation of errors, one or more parameters of the untrained machine learning prioritization model based on a comparison between the plurality of training outputs to the plurality of recovery labels to generate a trained machine learning prioritization model.

4. The computer-implemented method of claim 3, wherein:
(i) a historical data object pair of the plurality of historical data object pairs corresponds to a historical medical claim and a claim label for the historical medical claim,
(ii) the claim label is a binary label that identifies a positive label category or a negative label category for the historical medical claims,
(iii) the positive label category indicates that the historical medical claim resulted in a claim recovery, and
(iv) the negative label category indicates that the historical medical claim resulted in either (a) a claim closure without the claim recovery or (b) a recovery appeal to the claim recovery.

5. The computer-implemented method of claim 1, wherein generating the prioritized ranking data structure for the set of candidate data objects based on the plurality of composite recovery scores comprises:
generating a filtered set of candidate data objects by filtering the set of candidate data objects based on a comparison of the plurality of composite recovery scores with a tiered recovery score threshold; and
generating the prioritized ranking data structure by ranking the filtered set of candidate data objects.

6. The computer-implemented method of claim 5, wherein a candidate data object of the set of candidate data objects is associated with a composite recovery score and a predicted recovery parameter and the tiered recovery score threshold defines a plurality of composite recovery score thresholds respectively corresponding to a plurality of predicted recovery parameter ranges.

7. The computer-implemented method of claim 6, wherein the candidate data object is ranked based on a comparison of the composite recovery score to the predicted recovery parameter.

8. The computer-implemented method of claim 1, wherein the object data store comprises a plurality of data objects that are respectively associated with one or more prediction entities and identifying the set of candidate data objects from the object data store comprises:
identifying a target prediction entity based on one or more exclusionary entity statuses defined by the pre-filtering rule set;
identifying one or more candidate data objects corresponding to the target prediction entity; and
adding a candidate data object of the one or more candidate data objects to the set of candidate data objects based on a comparison between an object status of the candidate data object and an eligibility status defined by the pre-filtering rule set.

9. The computer-implemented method of claim 1, wherein the remote verification platform is an intermediary server configured to process the verification request in response to a value transfer.

10. The computer-implemented method of claim 1, further comprising:
receiving a time range for the selected data object from the remote verification platform; and
verifying the selected data object based on a comparison between a timing parameter of the selected data object to the time range.

11. The computer-implemented method of claim 1, wherein initiating the prediction-based action for the selected data object comprises providing the selected data object to a recovery model configured to:
identify a provider entity associated with the selected data object;
generate a recovery notification for the selected data object; and
provide the recovery notification to the provider entity.

12. The computer-implemented method of claim 1, further comprising:
storing the selected data object in a recovery training store as a historical data object;
receiving recovery data for the historical data object;
generating a recovery label for the historical data object based on the recovery data; and
retraining the machine learning prioritization model based on the historical data object and the recovery label.

13. The computer-implemented method of claim 12, wherein the recovery data identifies a recovery response to a request for reimbursement for a medical claim, and generating the recovery label comprises:
generating a negative label category when the recovery response identifies a recovery appeal or a claim closure without a claim recovery, or
generating a positive label category when the recovery response identifies a completed claim recovery and an expiration of an appeal deadline for the historical data object.

14. A computing system comprising memory and one or more processors communicatively coupled to the memory, the one or more processors configured to:
identify, using a pre-filtering rule set, a set of candidate data objects from an object data store;
generate, using a machine learning prioritization model, a plurality of composite recovery scores for the set of candidate data objects;
generate a prioritized ranking data structure for the set of candidate data objects based on the plurality of composite recovery scores;
provide, to a remote verification platform, a verification request for a selected data object of the set of candidate data objects based on the prioritized ranking data structure; and
responsive to a verification response from the remote verification platform, initiating a prediction-based action for the selected data object.

15. The computing system of claim 14, wherein the machine learning prioritization model comprises a decision tree classifier that is trained to generate a composite recovery score based on one or more predictive features of a data object.

16. The computing system of claim 15, wherein the machine learning prioritization model is trained by:
receiving a recovery training store comprising a plurality of historical data object pairs,
wherein the plurality of historical data object pairs comprises a plurality of historical data objects and a plurality of recovery labels that identify a plurality of recovery outcomes respectively corresponding to the plurality of historical data objects;
generating, using an untrained machine learning prioritization model, a plurality of training outputs based on the plurality of historical data objects; and
updating, using backpropagation of errors, one or more parameters of the untrained machine learning prioritization model based on a comparison between the plurality of training outputs to the plurality of recovery labels to generate a trained machine learning prioritization model.

17. The computing system of claim 16, wherein:
(i) a historical data object pair of the plurality of historical data object pairs corresponds to a historical medical claim and a claim label for the historical medical claim,
(ii) the claim label is a binary label that identifies a positive label category or a negative label category for the historical medical claims,
(iii) the positive label category indicates that the historical medical claim resulted in a claim recovery, and
(iv) the negative label category indicates that the historical medical claim resulted in either (a) a claim closure without the claim recovery or (b) a recovery appeal to the claim recovery.

18. The computing system of claim 14, wherein generating the prioritized ranking data structure for the set of candidate data objects based on the plurality of composite recovery scores comprises:
generating a filtered set of candidate data objects by filtering the set of candidate data objects based on a comparison of the plurality of composite recovery scores with a tiered recovery score threshold; and
generating the prioritized ranking data structure by ranking the filtered set of candidate data objects.

19. One or more non-transitory computer-readable storage media including instructions that, when executed by one or more processors, cause the one or more processors to:
identify, using a pre-filtering rule set, a set of candidate data objects from an object data store;
generate, using a machine learning prioritization model, a plurality of composite recovery scores for the set of candidate data objects;
generate a prioritized ranking data structure for the set of candidate data objects based on the plurality of composite recovery scores;
provide, to a remote verification platform, a verification request for a selected data object of the set of candidate data objects based on the prioritized ranking data structure; and
responsive to a verification response from the remote verification platform, initiating a prediction-based action for the selected data object.

20. The one or more non-transitory computer-readable storage media of claim 19, wherein the instructions further cause the one or more processors to:
store the selected data object in a recovery training store as a historical data object;
receive recovery data for the historical data object;
generate a recovery label for the historical data object based on the recovery data; and
retrain the machine learning prioritization model based on the historical data object and the recovery label.
